(19) United States
(12) Patent Application Publication
(10) Pub. No.: US 2007/0293766 A1
(43) Pub. Date: Dec. 20, 2007

(54) Transmission Based Imaging for Spectroscopic Analysis

(75) Inventors: Bernardus Leonardus Gerardus Bakker, Eindhoven (NL); Gerald Lucassen, Eindhoven (NL); Michael Cornelis Van Beek, Eindhoven (NL); Marjolein Van Der Voort, Eindhoven (NL); Robert Frans Maria Hendriks, Eindhoven (NL); Frank Jeroen Pieter Schuurmans, Eindhoven (NL)

Correspondence Address: PHILIPS INTELLECTUAL PROPERTY & STANDARDS, 595 MINER ROAD, CLEVELAND, OH, 44143, US

(73) Assignee: Koninklijke Philips Electronics N.V., Eindhoven (NL)

(21) Appl. No.: 11/574,163

(22) PCT Filed: Aug. 24, 2005
(86) PCT No.: PCT/IB05/52774

§ 371 Date: Feb. 23, 2007

(30) Foreign Application Priority Data
Aug. 27, 2004 (EP) 04104125.2

(51) Int. Cl. G01J 3/28

(52) U.S. Cl. 600/473; 356/326

(57) ABSTRACT

The present invention provides a spectroscopic system and a transmission based imaging system for a spectroscopic system as well as a probe head for a transmission based imaging system for a spectroscopic system and a corresponding transmission based imaging method. The spectroscopic system is preferably applicable to in vivo noninvasive blood analysis. Transmission based imaging makes use of a transmitted portion of an imaging or monitoring beam that has been transmitted through biological tissue. By means of transmission based imaging, a contrast decreasing impact of scattered radiation can be effectively reduced. Additionally, by arranging the imaging light source opposite to an objective lens of the spectroscopic system, unintended propagation of spectroscopic excitation radiation into free space can be effectively prevented.

The present invention relates to the field of optical imaging and optical spectroscopy and in particular without limitation to optical spectroscopy of biological tissue.

Usage of optical spectroscopy techniques for analytical purposes is as such known from the prior art. WO 02/057758 A1 and WO 02/057759 A1 show spectroscopic analysis apparatuses for in vivo non-invasive spectroscopic analysis of the composition of blood flowing through a capillary vessel of a patient. The position of the capillary vessel is determined by an imaging system in order to identify a region of interest to which an excitation beam for the spectroscopic analysis has to be directed. In principle, any imaging method providing sufficient visualization of a capillary vessel can be applied. The imaging as well as the spectroscopic analysis both make use of a common microscope objective enabling imaging of a capillary vessel on the one hand and allowing focusing of a near infrared (NIR) laser beam in the skin for exiting a Raman spectrum on the other hand. Moreover, the same microscope objective is used for collection of the scattered radiation evolving from the Raman processes.

By visual imaging of an area underneath the skin of a patient, the location of a capillary vessel can be exactly determined. The lateral position of the capillary vessel can be sufficiently determined by means of a two-dimensional image and its depth underneath the surface of the skin can in principle be obtained by suitable imaging methods featuring a sufficient depth of focus. Visualizing a distinct capillary vessel and hence determining its position underneath the surface of the skin allows to shift the focal spot of spectroscopic excitation radiation and the corresponding confocal detection volume of the spectroscopic analysis system into this distinct capillary vessel. In this way the capillary vessel specifies a volume of interest that becomes subject to spectroscopic analysis.

Generally, there exists a variety of suitable imaging methods that include Orthogonal Polarized Spectral Imaging (OPSI), Confocal Video Microscopy (CVM), Optical Coherence Tomography (OCT), Confocal Laser Scanning Microscopy (CLSM) and Doppler Based Imaging. In particular, OPSI and CVM provide visualization on the basis of a reflection geometry, i.e. the imaging is performed on the basis of radiation that is scattered and/or reflected by the sample that is subject to spectroscopic investigations. Hence, the optical source and the detection means for imaging of an area around a capillary vessel are located on the same side of the sample. In principle, reflection based imaging is universally applicable to a plurality of different parts of a human body. However, reflection based imaging strongly depends on scattering and absorption of light inside the sample. For example, the absorption coefficient for human skin strongly depends on the wavelength of the radiation and the depth underneath the surface of the skin. The depth underneath the surface of the skin further governs the spectral absorption properties of the skin tissue.

Moreover, the rather inhomogeneous internal structure of biological tissue in general may have a corresponding inhomogeneous impact on the optical absorption and scattering properties of tissue. For example, a blood capillary filled with blood features a different molecular composition than the surrounding cellular tissue. Therefore, the optical absorption, scattering and reflection properties of capillary vessels typically differ from the optical properties of the surrounding tissue.

Further, for imaging techniques that are based on the reflection geometry, scattering may appreciably decrease the quality of an obtained image. Typically, scattered and back-scattered light leads to a decrease in contrast of an image obtained by means of an reflection based optical arrangement. Scattering is inevitably present and remarkably reduces image quality and contrast an acquired image. The impact of scattering on image contrast and image quality also strongly depends on the penetration depth of the imaging radiation.

In order to obtain images of reasonable quality, imaging based on the reflection geometry is practically limited to a few sets of imaging wavelengths, blood vessel diameters and depths underneath the skin surface. For example, making use of OPSI at a wavelength of 530 nanometers in a depth of 80 micrometers under the skin surface, good images can be obtained for blood vessels featuring a size around 10 micrometers. Optimal imaging of capillary vessels featuring a different size either requires a different imaging depth and/or a different imaging wavelength. These restrictions clearly limit the application area of an imaging system and its universality.

Due to the above described scattering, reflection and absorption properties of biological tissue, it is rather difficult to obtain visual images of reasonable quality from different depths in a biological sample by making use of an imaging technique based on the reflection geometry. Moreover, the reflection geometry inherently does not allow to simultaneously obtain a good quality image showing biological structures of different size, like e.g. capillary vessels with variable dimensions.

The present invention therefore aims to provide a spectroscopic system with an improved imaging system allowing for a higher flexibility of imaging of biological structures underneath the surface of biological tissue.

The present invention provides a spectroscopic system for determining a property of a biological tissue. The inventive spectroscopic system has an objective for directing an excitation beam into a volume of interest and for collecting return radiation from the volume of interest. The spectroscopic system comprises a light source for generating at least a first monitoring beam that has a first wavelength. This first monitoring beam is directed into the biological tissue. The inventive spectroscopic system further comprises a light detector for detecting at least a portion of the first monitoring beam that is transmitted through the biological tissue. The spectroscopic system further comprises imaging means for generating a visual image on the basis of the transmitted portion of the first monitoring beam that is detected of the transmission through the biological tissue by means of the light detector.

The invention provides an imaging that is based on transmission of an imaging or monitoring beam. In this way a negative impact on image quality that is due to scattering of light can be effectively reduced. Typically, in such a transmission geometry, only light is detected that is not subject to deflection during transmission through the biological tissue. In contrast, light being deflected during propagation through the biological tissue is almost not detected by means of detector. Since, deflection of light is mainly governed by a scattering processes inside a sample, the impact of scattering on the image quality can be remarkably reduced. This can be effectively achieved by arranging the light detector substantially opposite to the light source, or by arranging the detector on the optical axis of the imaging or monitoring beam.

Since the transmission based imaging requires a transmission of the monitoring or imaging beam through the biological tissue, the intensity and/or wavelength of this first monitoring beam has to be adapted to the optical properties, i.e. the transmission, reflection and absorption properties of the biological tissue that shall become subject to spectroscopic analysis. Therefore, the transmitted portion of the first monitoring beam has to provide at least an intensity that is above a lower sensitivity threshold of the light detector.

The transmission based imaging is preferably applicable to biological objects that are limited in size or that feature a limited thickness. In this way it can be effectively prevented that the at least first monitoring or imaging beam is completely absorbed or scattered by the biological tissue. With respect to the human body, the inventive transmission imaging is preferably applicable to an appendix, like e.g. ear lobe, nostril, lip, tongue, cheek or finger. In particular, these parts of a body also allow for an effective fixing of the spectroscopic system by means of the e.g. clipping or clamping.

Moreover, the transmission based imaging allows for visualizing biological structures of different size at different depths inside the biological tissue. Since in transmission geometry the spectral absorption and/or scattering of the monitoring or imaging beam is inherently constant and basically depends only on the thickness of the sample, a visual image can be effectively generated on the basis of absorption and/or scattering.

Absorption based transmission imaging makes effective use of inhomogeneous absorption properties of the biological tissue. For example, a capillary vessel that is filled with blood may feature a high absorption coefficient for the first wavelength whereas the surrounding cellular tissue may feature a rather low absorption coefficient for the same wavelength. In such a constellation, absorption is mainly governed by capillary vessels that are preferably subject of the imaging procedure and whose transverse or three-dimensional location has to be determined by means of the imaging procedure.

Transmission based imaging may also effectively exploit scattering of the monitoring or imaging beam inside the biological tissue. In contrast to the reflection geometry, where only backscattered light is used for imaging, in the transmission geometry, image information is obtained by means of a scattered portion of the imaging beam, that is subject to deflection and which is consequently not detected by means of the detector. In this way, e.g. the position of a capillary vessel featuring a high scattering coefficient can be determined irrespectively of a scattering angle. Compared to the reflection geometry, where only backscattered light can be effectively detected, here, biological structures can be imaged on the basis of absent portions of the transmitted imaging beam, that are either due to scattering or due to absorption. Compared to the reflection based imaging, the image contrast might be appreciably enhanced.

According to a preferred embodiment of the invention, the objective of the spectroscopic system further provides collection of the transmitted portion of the first monitoring beam. Hence, the objective's function is twofold. First, it serves to focus excitation radiation into the volume of interest and to collect return radiation from the volume of interest that is spectrally analyzed. Second, the objective serves as an imaging lens for the transmission based imaging system. Therefore, the light source for generating the at least first monitoring beam is arranged opposite to the objective. Consequently, the biological sample is sandwiched between the light source and the objective of the spectroscopic system.

Acquisition of spectroscopic data, i.e. return radiation emanating from the volume of interest, is typically performed by means of a reflection geometry. Hence, the spectroscopic excitation beam is directed into the volume of interest and counter propagating back-scattered radiation is spectrally analyzed. Arranging the light source for the imaging system opposite to the objective lens of the spectroscopic system, inherently provides an effective safety mechanism for the spectroscopic system. Typically, the excitation beam features a wavelength in the non-visible near infrared (NIR) spectral range and has appreciable power that might be hazardous to an operator, especially when e.g. hitting the operator's eyes. Since the imaging light source is oppositely arranged to the objective of the spectroscopic system, the excitation beam is prevented from propagating into free space even when no biological sample is present between imaging light source and objective.

According to a further preferred embodiment of the invention, the biological tissue comprises blood capillaries or blood vessels and the first wavelength is in the visible range. Preferably the blood capillaries or blood vessels of the biological tissue feature a high absorption coefficient for the first wavelength. Additionally, the surrounding tissue, i.e. cellular tissue that does not provide a substantial blood flow, features a rather low absorption coefficient for the first wavelength. A typical range for the first wavelength is given by e.g. 530 nm to 600 nm. The optimum wavelength is given by the diameter of the blood vessels that have to be imaged and the depth of these blood vessels below the surface of the biological sample, e.g. the human skin tissue.

According to a further preferred embodiment of the invention, the spectroscopic system further comprises at least a second monitoring beam that has a second wavelength. This second monitoring beam is either generated by means of the first light source or by means of an at least second light source. Additionally, the light detector is further adapted to detect at least a portion of the at least second monitoring beam that is transmitted through the biological tissue. Preferably, the blood vessels or blood capillaries to be imaged by the imaging system feature a low absorption coefficient for the second wavelength.

In this way a second image can be obtained that shows a different transverse intensity distribution than the image taken by means of the first wavelength. Acquisition of the second image by means of the second wavelength referring to the same area around the volume of interest effectively allows to compare these first and second images. Comparison of these first and second images acquired by means of first and second wavelengths therefore provides a sufficient and reliable means to accurately determine the position of capillary vessels inside a biological sample.

Acquisition of two images based on different wavelength effectively allows to determine whether a dark spot in a first image is due to absorption, reflection or scattering. Assuming that a blood vessel is highly absorptive for the first wavelength but features a high transmission coefficient for the second wavelength, a dark spot in the first and second image does therefore not correspond to a capillary blood vessel. As a consequence by making use of first and second wavelength an error rate for blood vessel or blood capillary determination and corresponding location determination can be effectively reduced.

According to a further preferred embodiment of the invention, the second wavelength is in the infrared spectral range. Preferably, the second wavelength is even in the near infrared spectral range. For example, the second wavelength may range from 850 nanometers to 1050 nanometers. The light source or light sources for generating the first and/or second wavelengths can be implemented on the basis of light emitting diodes (LED), a gas discharge lamp, or some incandescent light source in combination with color or band pass filters.

Generally, the light source itself does not have to be located opposite to the objective of the spectroscopic system and hence near the sample of investigation. Instead, the light source can be located at a remote location and its radiation can be transmitted via some fiber optical means to the desired position within the spectroscopic system. Furthermore, the light source itself does not have to provide the spectral range specified by the first and second wavelengths. The required spectral ranges in the visible and infrared can in general be produced by means of a broadband light source in combination with a narrow band spectral filter, such as e.g. an interference filter. Making use of two adequate spectral filters, first and second wavelengths might be easily generated on the basis of a common broadband light source, such as e.g. a halogen lamp.

According to a further preferred embodiment of the invention, the spectroscopic system further comprises a probe head for carrying the objective and the light source. The probe head is adapted to be coupled to a base station of the spectroscopic system. The base station in turn provides a spectroscopic analysis unit and the imaging means. The probe head is coupled to the base station preferably by means of a fiber optic arrangement that provides a bidirectional transmission of optical signals from and to the probe head. Typically, the probe head is designed as a compact device that allows for flexible handling and facile attachment to designated parts of the human body. Therefore the probe head only has to provide the objective of the spectroscopic system for directing excitation radiation and for collecting return radiation as well as for collecting transmitted imaging radiation. Preferably, the probe head further comprises the imaging light source that is oppositely arranged with respect to the objective. Alternatively, instead of implementing the light source itself into the probe head, the imaging light source for generating first and/or second imaging wavelengths might be implemented into the base station of the spectroscopic system. In this case the imaging radiation produced by the imaging light source has to be transmitted to the probe head by means of e.g. an optical fiber.

In another aspect, the invention provides a probe head for a spectroscopic system. The spectroscopic system is adapted to determine a property of a biological tissue, preferably in a non-invasive way. The probe head of the spectroscopic system comprises a light source for generating at least a first monitoring or imaging beam that has a first wavelength. This first monitoring beam is adapted to be directed into the biological tissue. The probe head further comprises an objective for directing an excitation beam into a volume of interest and for collecting return radiation from the volume of interest. The objective is further adapted to collect a portion of the at least first monitoring beam that is transmitted through the biological tissue. Consequently, the probe head features a geometric shape providing an opposite arrangement of the objective and the light source. In this way radiation being emitted by the light source as first monitoring or imaging beam is at least partially transmitted through the biological tissue and the transmitted portion can be collected by means of the objective.

Instead of incorporating the light source for generating the at least first monitoring or imaging beam into the probe head, the light source might be alternatively provided by a base station of the spectroscopic system and the at least first monitoring beam may be transmitted to the probe head by means of an optical fiber connecting the light source and the probe head.

According to a preferred embodiment of the invention, the light source is arranged opposite to the objective and the biological tissue can be positioned between the objective and the light source. Hence, the geometric shape of the probe head allows for interstitial positioning of the biological tissue between the objective and the light source of the probe head. Here, the light source can be effectively represented by a light emitting aperture of e.g. an optical fiber that is coupled to the light source, that is in turn located at a remote location.

According to a further preferred embodiment of the invention, the probe head further comprises a light detector for detecting at least a portion of the first monitoring beam that is transmitted through the biological tissue. In this embodiment optical detection of the transmitted monitoring beam is directly performed in the probe head. In this way a collected transmitted imaging or monitoring radiation does not have to be transmitted to the imaging means of the base station of the spectroscopic system. Moreover, by detecting the transmitted portion of the first monitoring or imaging beam by means of the probe head, the imaging means are at least partially implemented already by means of the probe head. Detection of the transmitted portion of the monitoring or imaging beam can be effectively provided by means of a charge coupled device (CCD) providing a sufficient spatial resolution for imaging of a capillary vessel inside the biological tissue.

According to a further preferred embodiment of the invention, the probe head further comprises fixing means for fixing the probe head to the surface of the biological tissue. Preferably, the probe head and hence its geometric shape is adapted for attachment to an appendix of e.g. the human body, like ear lobes, nostrils, tongue, inner cheeks or finger. The fixing means provide efficient attachment of the probe head to a dedicated portion of a human body either by means of adhesive elements, clamping or clipping elements or any other type of fixing means that are suitable for attaching the probe head to one of the above mentioned body parts. Preferably, the probe head features a compact and light weight design that allows for a maximum of patient comfort during an examination procedure making use of the inventive analysis system.

According to a further preferred embodiment of the invention, the fixing means further comprise a first and a second clamping element. The first clamping element comprises the light source and the second clamping element comprises the objective. In this embodiment, the fixing means and the probe head are implemented as a clamp like device. Preferably, the first and the second clamping element are adapted to rotate around a common axis. Additionally, the first and second clamping elements may become subject to some kind of clamping force.

According to a further preferred embodiment of the invention, the first and second clamping elements are adapted to exert mechanical stress to the surface of the biological tissue. This mechanical stress is generated on the basis of a spring force or a magnetic force. Additionally, the surface of the first and second clamping element may provide an appreciable frictional resistance that supports mechanical fixing of the biological sample with respect to the probe head and the first and/or second clamping elements of the probe head.

In still another aspect, the invention provides a method of generating a visual image of a biological tissue for determining the position of a volume of interest inside the biological tissue. The inventive method comprises the steps of generating at least a first monitoring beam having a first wavelength by means of a light source, directing the first monitoring beam into the biological tissue, detecting at least a portion of the first monitoring beam that is transmitted through the biological tissue and generating a visual image on the basis of the transmitted portion of the first monitoring beam for determining the position of the volume of interest inside the biological tissue.

Further, it is to be noted, that any reference signs and the claims are not to be construed as limiting the scope of the present invention.

In the following preferred embodiments of the invention will be described in detail by making reference to the drawings in which:

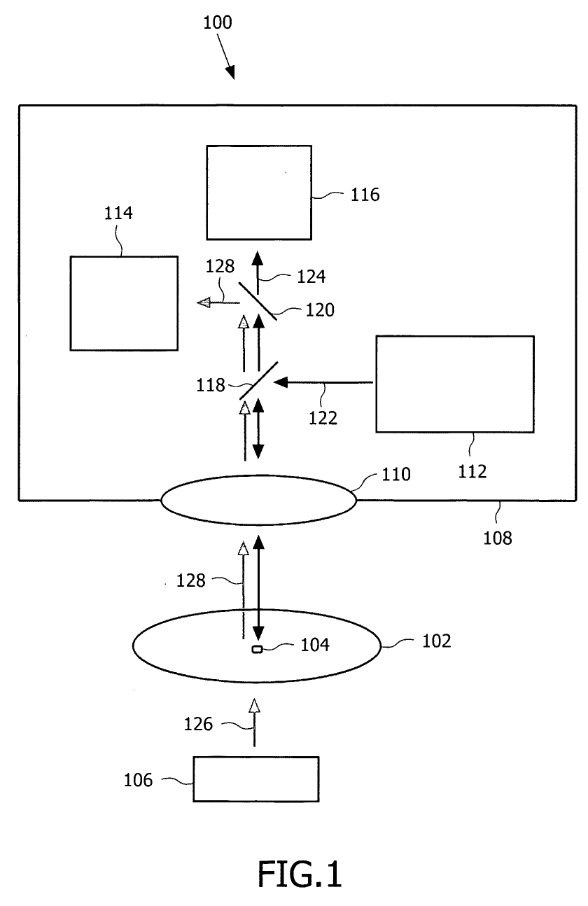

FIG. 1 schematically shows a block diagram of the spectroscopic system,

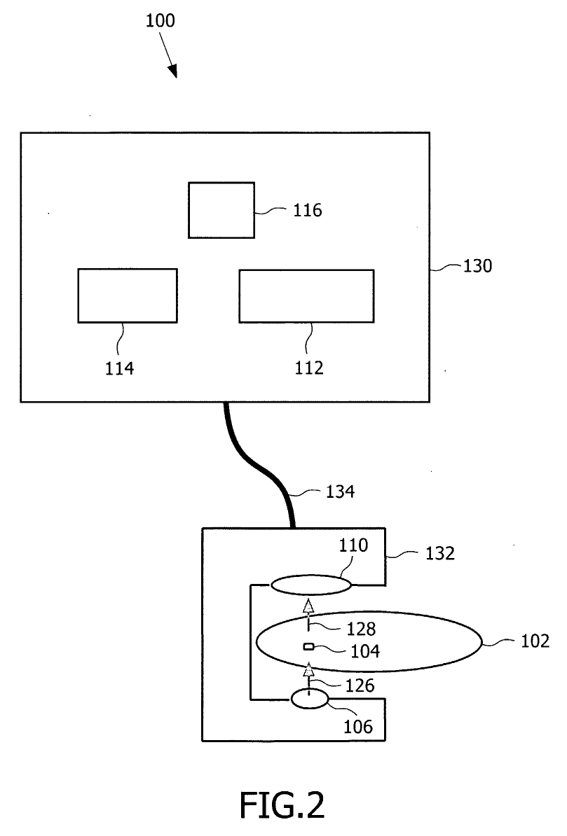

FIG. 2 shows a schematic block diagram of a base station and a probe head of the spectroscopic system,

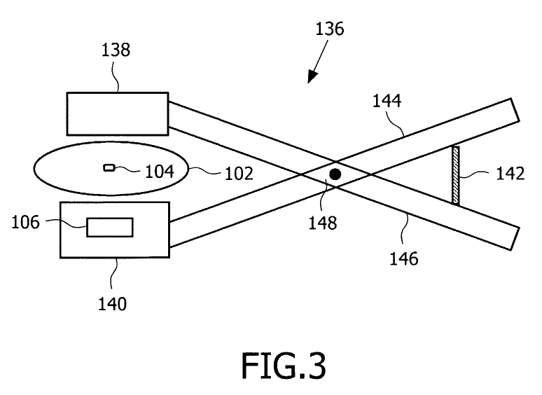

FIG. 3 schematically shows a cross sectional view of the probe head being adapted for clamping,

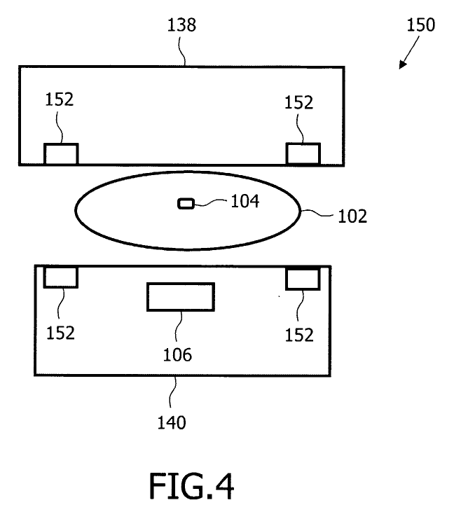

FIG. 4 illustrates a cross sectional view of a probe head with magnetic based fixing means.

FIG. 1 schematically shows a block diagram of the spectroscopic system 100. The spectroscopic system 100 comprises a base station 108 as well as a light source 106. the spectroscopic system is adapted to spectrally analyzed a volume of interest 104 that is located inside a biological tissue 102. Preferably, the entire spectroscopic system can be applied for in vivo non-invasive blood analysis of a person or an animal. For example, the volume of interest 104 may represent a capillary vessel that is filled with blood or provides a blood flow.

The spectroscopic system 100 further has an excitation beam source 112, an imaging unit 114 as well as a spectroscopic unit 116. Moreover, the spectroscopic system 100 further has optical components, such as beam splitters 118, dichroic mirror 120 and an objective lens 110. Additional optical components that serve for e.g. confocal propagation of optical signals or lateral imaging of a region around the volume of interest 104 are not explicitly shown here. Optical components 118 and 120 are illustrated as beam splitter and dichroic mirror. However, depending on the applied wavelength and the concrete arrangement of the spectroscopic system 100, both of the two components 118 and 120 may also be implemented as beam splitters or alternatively as dichroic mirrors.

The various components of the spectroscopic system, in particular excitation beam source 112, objective 110, imaging unit 114 and spectroscopic unit 116 by no means have to be implemented in a single constructional unit as represented by the base station 108.

Excitation radiation 122 generated by means of the excitation beam source 112 is directed and focused into the volume of interest 104 by means of the beam splitter 118 and the objective lens 110. Inside the volume of interest 104 the excitation radiation 122 may induce a plurality of scattering processes of either elastic and inelastic type. A portion of back-scattered excitation radiation reenters the objective 110 as return radiation comprising spectral information that allows to determine e.g. the molecular composition of the volume of interest 104. Since the return radiation typically has contributions from elastic and inelastic scattered radiation, the dichroic mirror 120 serves to spatially separate elastic and inelastic scattered radiation. In this way elastically scattered radiation can be effectively prevented from entering the spectroscopic unit 116. Hence, the dichroic mirror 120 features a high reflection or absorption for the wavelength of the excitation radiation 122.

Inelastic scattering processes may refer to Stokes or Anti-Stokes scattering leading to a Raman spectrum of a substance that is located inside the volume of interest.

In order to obtain a high signal two noise ratio for the spectroscopic signal, the focus of the excitation beam 122 preferably has to overlap with the volume of interest 104 to a high degree. Therefore, a region around the volume of interest 104 can be visually imaged by means of the imaging unit 114 in order to determine the location of the volume of interest, e.g. the location of a capillary blood vessel. Therefore, the light source 106 is adapted to emit a monitoring or imaging light beam 126 into the biological tissue 102. Preferably, the wavelength of the monitoring beam 126 is chosen such that the monitoring beam 126 is highly absorbed by means of the volume of interest 104, i.e. by a blood vessel and that the surrounding tissue 104 features a low absorption and/or scattering coefficient for the wavelength of the monitoring beam 126.

The portion 128 of the monitoring beam 126 that is transmitted through the biological tissue 102 enters the spectroscopic system 100 via the objective lens 110. The optical arrangement of the spectroscopic system 100 is adapted to transmit the transmitted monitoring beam 128 to the imaging unit 114. The imaging unit 114 typically comprises a detector in form with a light sensitive area with a high spatial resolution, such as a CCD chip. Typically, the imaging unit 114 is adapted to detect the transmitted monitoring beam 128 and to generate a visual image of a region around the volume of interest 104, that allows locate and to track the volume of interest.

Since the monitoring beam 126 is preferably absorbed by the volume of interest 104, a capillary vessel might be represented as a dark structure in the generated visual image. However, such a dark structure may not necessarily stem from absorption of the monitoring beam 126. Moreover, dark spots in the generated visual image may also appear due to scattering or reflection. In order to increase reliability and accuracy of the imaging system, the light source 106 may further provide a second monitoring beam featuring a second wavelength for which the volume of interest 104, i.e. the capillary blood vessel, feature a low absorption coefficient. By sequentially or simultaneously transmitting first and second monitoring beams into the biological tissue 102, corresponding first and second images can be obtained by means of the imaging unit 114. By comparing first and second visual images, dark structures in the first or second images might be unequivocally determined and classified as a capillary blood vessel, hence as a structure that is of interest for non-invasive blood analysis.

First and second monitoring beams are not explicitly illustrated in FIG. 1. Preferably, first and second monitoring or imaging beams propagate along the same optical path. Therefore, the first and second corresponding images inherently provide a visual image of the same area around the volume of interest 104. Preferably, acquisition of first and second visual images on the basis of first and second imaging wavelengths is performed sequentially. Alternatively, when the light sensing structure of the imaging unit 114 allows for simultaneous separate detection of different spectral components, acquisition of first and second visual images may also be performed simultaneously.

Compared to a reflection based imaging method, the transmitted portion of the monitoring beam 128 is effectively independent of the location and depth of the volume of interest 104 underneath the surface of the biological tissue 102. Assuming that the biological tissue 102 features a rather homogeneous thickness, the total absorption of the monitoring beam 126 remains substantially constant. In contrast, when making use of imaging based on a reflection geometry, the amount of reflected light strongly depends on the depth of the volume of interest 104 inside the biological tissue 102. Moreover, in reflection geometry, the length of the light path of the imaging radiation inside the sample may become as long as twice the thickness of the sample, in particular, when the volume of interest 104 is located near the bottom side of a biological tissue 102.

Compared to the reflection geometry, the transmission based imaging intrinsically provides absorption of the imaging radiation irrespectively of the depth of the volume of interest 104 inside the biological tissue 102. Additionally, blood vessels of arbitrary size can be sufficiently image at various depth underneath the surface of the sample for an optimum image quality. The wavelength of the imaging radiation 126 might be adapted to the geometric configuration and position of the volume of interest 104.

FIG. 2 shows another schematic block diagram of the spectroscopic system 100. Here, the spectroscopic system 100 is divided into a base station 130 and a probe head 132. Preferably, the base station 130 comprises the excitation beam source 112, the spectroscopic unit 116 and the imaging unit 114. The objective lens 110 as well as the light source 106 for imaging are implemented into the probe head 132. Since the probe head 132 only provides a few optical components it can be designed in a compact and flexible way. Preferably, the probe head 132 has a geometric shape that allows for inserting the biological tissue 102 between the light source 106 and the objective 110. In this way the probe head provides transmission based visual imaging of a region around the volume of interest 104 inside the biological tissue 102. Probe head 132 and base station 130 are preferably connected by means of a single or a plurality of optical fibers 134. In this way optical signals for visualization as well as for spectroscopic analysis can be directionally transmitted between base station 130 and probe head 132.

Alternative to the illustrated embodiment of FIG. 2, the light source 106 might also be implemented inside the base station 130. In this case imaging radiation 126 generated by light source 106 has to be transmitted to the probe head via the optical fiber 134. In the bottom part of the probe head 136 the light source 106 may then effectively be replaced by a light emitting aperture of a corresponding optical fiber.

Additionally, the imaging unit 114 or at least parts of the imaging unit, e.g. a light detecting element, might be implemented into the probe head 132. For example, a light sensitive CCD chip might be implemented into the probe head 132 that provides transformation of optical image information into corresponding electrical signals. These electrical signals may then be transmitted to the base station 130 for further processing and for generating and visualizing a visual image on the basis of the transmitted monitoring radiation 128.

FIG. 3 schematically shows a cross sectional view of a probe head 136 that is implemented as a clamping device. This probe head 136 has two clamping elements 144, 146 that are free to rotate around the rotation axis 148. One end of the clamping element 144 has a light source module 140 providing the imaging light source 106 and the oppositely located end of the clamping element 146 has a detection module 138 providing the objective lens 110 for acquisition of transmitted imaging radiation. Additionally, the two clamping elements 144, 146 are mechanically coupled to a spring 142, that serves to exert a force onto the two clamping elements 144, 146.

In principle, the spring 142 can either be coupled to the two clamping elements 144, 146 on the right side or on the left side of the rotation axis 148. Depending on the concrete implementation, the spring 142 either has to exert a pushing or an attraction onto the two clamping elements 144, 146. In either way the probe head 136 is adapted to clamp the biological tissue 102. Clamping of the probe head 136 is preferably applicable, when the biological tissue 102 is represented by an appendix of the human body, like ear lobe, nostril, tongue, cheek, lip or a finger. Additionally, the surface of the detection module 138 and of the light source module 140 may provide an appreciable surface roughness featuring a frictional resistance that is in fact advantageous for fixing the biological tissue 102 with respect to the probe head 136 and in particular with respect to the detection module 138 and the light source module 140.

FIG. 4 schematically depicts another embodiment of a probe head 150 that also comprises a detection module 138 and a light source module 140. In contrast to the embodiment illustrated in FIG. 3, the probe head 150 does not make use of clamping elements in combination with a spring force. Here, the two modules of the probe head 138, 140 are not mechanically connected. Both modules 138, 140 feature magnetic elements 152 that serve to provide an attractive force between the two modules 138, 140 of the probe head 150. Preferably, the magnetic elements 152 can be implemented on the basis of permanent magnets or electrically controllable magnetic elements. Additionally, at least one of the magnetic elements 152 can be effectively replaced by a ferromagnetic material.

Even though the embodiment of probe head 150 clearly deviates from the embodiment of probe head 136, it also effectively provides a clamping of the probe head 150 to the biological tissue 102. Also here, the surface of the detection module 138 and the surface of the light source module 140 may additionally provide adhesion and/or a sufficient frictional resistance in order to prevent sliding of the biological tissue 102 with respect to any of the modules 138, 140.

In particular, the clamping embodiments of the probe head 136, 150 in combination with a compact design allows for a flexible handling and facile attachment to specific parts of e.g. a human body. For example, attaching a probe head to an ear lobe requires geometric dimensions of the probe head that do not exceed a few centimeters as well as a light weight implementation of the probe head in order to provide sufficient patient comfort during the non-invasive blood analysis.

### LIST OF REFERENCE NUMERALS

100 spectroscopic system
102 biological tissue
104 volume of interest
106 light source
108 base station
110 objective
112 excitation beam source
114 imaging unit
116 spectroscopic unit
118 beam splitter
120 dichroic mirror
122 excitation beam
124 return radiation
126 monitoring beam
128 transmitted monitoring beam
130 base station
132 probe head
134 optical fiber
136 probe head
138 detection module
140 light source module
142 spring
144 clamping element
146 clamping element
148 rotation axis
150 probe head
152 magnetic element

1. A spectroscopic system for determining a property of a biological tissue, the spectroscopic system having an objective for directing an excitation beam into a volume of interest and for collecting return radiation from the volume of interest, the spectroscopic system comprising:
a light source for generating at least a first monitoring beam having a first wavelength, the first monitoring beam being adapted to be directed into the biological tissue,
a detector for detecting at least a portion of the first monitoring beam being transmitted through the biological tissue,
imaging means for generating a visual image on the basis of the transmitted portion of the first monitoring beam.

2. The spectroscopic system according to claim 1, wherein the objective further providing collection of the transmitted portion of the first monitoring beam, the light source being arranged opposite to the objective.

3. The spectroscopic system according to claim 1, wherein the biological tissue comprises blood capillaries or blood vessels and the first wavelength is in the visible range.

4. The spectroscopic system according to claim 1, further comprising at least a second monitoring beam having a second wavelength, the at least second monitoring beam being generated by means of the first light source or by means of an at least second light source, the light detector being further adapted to detect at least a portion of the at least second monitoring beam being transmitted through the biological tissue.

5. The spectroscopic system according to claim 4, wherein the second wavelength is in the infrared spectral range.

6. The spectroscopic system according to claim 1, further comprising a probe head for carrying the objective and the light source, the probe head being adapted to be coupled to a base station of the spectroscopic system, the base station providing a spectroscopic analysis unit and the imaging means.

7. A probe head for a spectroscopic system, the spectroscopic system being adapted to determine a property of a biological tissue, the probe head comprising:
a light source for generating at least a first monitoring beam having a first wavelength, the first monitoring beam being adapted to be directed into the biological tissue,
an objective for directing an excitation beam into a volume of interest and for collecting return radiation from the volume of interest, the objective being further adapted to collect a portion of the at least first monitoring beam being transmitted through the biological tissue.

8. The probe head according to claim 7, wherein the light source is arranged opposite to the objective and wherein the biological tissue can be positioned between the objective and the light source.

9. The probe head according to claim 7, further comprising a detector for detecting at least a portion of the first monitoring beam being transmitted through the biological tissue.

10. The probe head according to claim 7, further comprising fixing means for fixing the probe head to the surface of the biological tissue.

11. The probe head according to claim 10, wherein the fixing means further comprise a first and a second clamping element, the first clamping element comprising the light source and the second clamping element comprising the objective.

12. The probe head according to claim 11, wherein the first and second clamping elements are adapted to exert mechanical stress to the surface of the biological tissue, the mechanical stress being generated on the basis of a spring force or a magnetic force.

13. A method of generating a visual image of a biological tissue for determining the position of a volume of interest inside the biological tissue, the method comprising the steps of:
generating at least a first monitoring beam by means of a light source, the at least first monitoring beam having a first wavelength,
directing the first monitoring beam into the biological tissue,
detecting at least a portion of the first monitoring beam being transmitted through the biological tissue,
generating a visual image on the basis of the transmitted portion of the first monitoring beam for determining the position of the volume of interest inside the biological tissue.

14. The method of claim 13, wherein the first monitoring beam is generated in a direction through the biological tissue and opposite to an objective that allows for the detecting of at least a portion of the first monitoring beam.

15. The method of claim 13 further comprising generating at least a second monitoring beam by means of the light source, wherein the at least second monitoring beam has a second wavelength different from the first wavelength of the first monitoring beam.

16. A spectroscopic system for determining a property of a biological tissue, the spectroscopic system having an objective for directing an excitation beam into a volume of interest and for collecting return radiation from the volume of interest, the spectroscopic system comprising:
a light source for generating at least a first monitoring beam having a first wavelength, the first monitoring beam being directed into the biological tissue,
a detector for detecting at least a portion of the first monitoring beam being transmitted through the biological tissue,
an imaging unit for generating a visual image on the basis of the transmitted portion of the first monitoring beam.

17. The spectroscopic system of claim 16, wherein the light source is positioned to direct the at least first monitoring beam through the biological tissue and to an objective locate opposite the light source.

18. The spectroscopic system of claim 16, wherein the light source generates at least two different monitoring beams, wherein the monitoring beams have different wavelengths.

19. The spectroscopic system of claim 16 further comprising a clamping means for securing the light source proximate the biological tissue.

20. The spectroscopic system of claim 17 further comprising a clamping means for securing the light source proximate the biological tissue and opposite to the objective.
